(19) United States
(12) Patent Application Publication
(10) Pub. No.: US 2006/0093319 A1
(43) Pub. Date: May 4, 2006

(54) Method of reproducing contents data and apparatus for reproducing the same

(75) Inventor: Naoki Kobayashi, Chiisagata-gun (JP)

Correspondence Address: BIRCH STEWART KOLASCH & BIRCH, PO BOX 747, FALLS CHURCH, VA, 22040-0747, US

(73) Assignee: Shinano Kenshi Kabushiki Kaisha

(21) Appl. No.: 11/249,260

(22) Filed: Oct. 14, 2005

(30) Foreign Application Priority Data
Oct. 29, 2004 (JP) 2004-317107

(51) Int. Cl. H04N 5/783

(52) U.S. Cl. 386/68

(57) ABSTRACT

The method of reproducing contents data is capable of smoothly reproducing video pictures in the special reproductions. The method comprises the steps of: determining a reduction coefficient for reducing a computing amount of the contents data to be actually decoded by a decoder, which processes video data of the contents data, on the basis of an amount of the data to be computed by the decoder while reproducing the contents data and a computable data amount of the decoder; reducing the computing amount of the contents data to be actually decoded by the decoder to a multiple of the reduction coefficient; processing video data of the contents data, whose computing amount has been reduced by the decoder; and displaying the processed video data of the contents data by display means.

### BACKGROUND OF THE INVENTION

The present invention relates to a method of reproducing contents data and an apparatus for reproducing contents data, more precisely relates to a method of reproducing contents data, which is capable of displaying smooth video pictures at different speeds, without using a high speed decoder, by reducing amount of data to be inputted to a decoder, and an apparatus for performing said method.

These days, apparatuses for reproducing video pictures from contents data, which have been read from hard disks, optical disks, etc., become popular. In such apparatuses for reproducing contents data, limit speeds for reproducing data are predetermined. The limit speeds relate to limits of computing performances of decoders for processing video data. Therefore, the conventional apparatuses cannot smoothly reproduce or playback video pictures when special reproductions of the contents data, e.g., reproduction with fast-forwarding, reproduction with fast rewinding, slow reproduction, slow reproduction with rewinding, are executed.

Thus, the conventional apparatuses employ high performance decoders (video decoders) to smoothly reproduce video pictures even in the special reproductions.

As described above, smooth video pictures can be reproduced by the high performance decoders, but manufacturing costs of the reproducing apparatuses must be higher.

High quality of video pictures is not required in the special reproductions, and the conventional decoders can smoothly reproduce video pictures in the special reproductions by reducing a computing amount of contents data inputted to the decoder.

Conventionally, B-pictures or intermediate data of group of pictures (GOP) section are completely deleted to reduce the computing amount of contents data. By this method, the apparatus employing an expensive high performance decoder is capable of smoothly reproducing the reduced data even at high speed, but the apparatus employing an inexpensive decoder cannot smoothly reproduce the reduced data, from which the B-pictures have been deleted, in the special reproductions.

### SUMMARY OF THE INVENTION

An object of the present invention is to provide a method of reproducing contents data, which is capable of smoothly reproducing video pictures in the special reproductions, without using an expensive high performance decoder, by reducing a computing amount of data to be processed by a decoder.

Another object of the present invention is to provide an apparatus for performing said method of the present invention.

To achieve the objects, the present invention has following structures.

Namely, the method of reproducing contents data stored in storing means at a speed other than normal speed,

comprises the steps of:

determining a reduction coefficient for reducing a computing amount of the contents data to be actually decoded by a decoder, which processes video data of the contents data, on the basis of an amount of the data to be computed by the decoder while reproducing the contents data and a computable data amount of the decoder;

reducing the computing amount of the contents data to be actually decoded by the decoder to a multiple of the reduction coefficient;

processing video data of the contents data, whose computing amount has been reduced, by the decoder; and

displaying the processed video data of the contents data by display means.

In the method, the computing amount of the contents data to be actually decoded by the decoder may be reduced by translating the contents data.

Further, in the method, the computing amount of the contents data to be actually decoded by the decoder may be reduced by transcoding the contents data.

On the other hand, the apparatus for reproducing contents data,

comprises:

means for storing the contents data;

means for reducing a computing amount of the contents data;

a decoder for processing video data of the contents data, whose computing amount has been reduced by the reducing means;

display means; and

control means,

the control means determines a reduction coefficient for reducing a computing amount of the contents data to be actually decoded by a decoder, which processes video data of the contents data, on the basis of an amount of the data to be computed by the decoder while reproducing the contents data and a computable data amount of the decoder,

reduces the computing amount of the contents data to be actually decoded by the decoder to a multiple of the reduction coefficient,

processes video data of the contents data, whose computing amount has been reduced by the decoder, and

displays the processed video data of the contents data by the display means.

In the apparatus, the reducing means may be a translator.

Further, in the apparatus, the reducing means may be a transcoder.

By the method and the apparatus of the present invention, the computing amount of the data to be processed by the decoder can be reduced in the special reproductions. Therefore, even if the apparatus employs an inexpensive decoder, the decoder has enough data processing capacity so that smooth video pictures can be reproduced in the special reproductions.

### BRIEF DESCRIPTION OF THE DRAWINGS

Embodiments of the present invention will now be described by way of examples and with reference to the accompanying drawings, in which:

FIG. 1 is a block diagram of the apparatus of an embodiment of the present invention;

FIG. 2 is a file-processing flowchart of the embodiment; and

FIG. 3 is a schematic view showing a process of reducing a computing amount of data performed by reducing means.

### DETAILED DESCRIPTION OF THE EMBODIMENTS

Preferred embodiments of the present invention will now be described in detail with reference to the accompanying drawings.

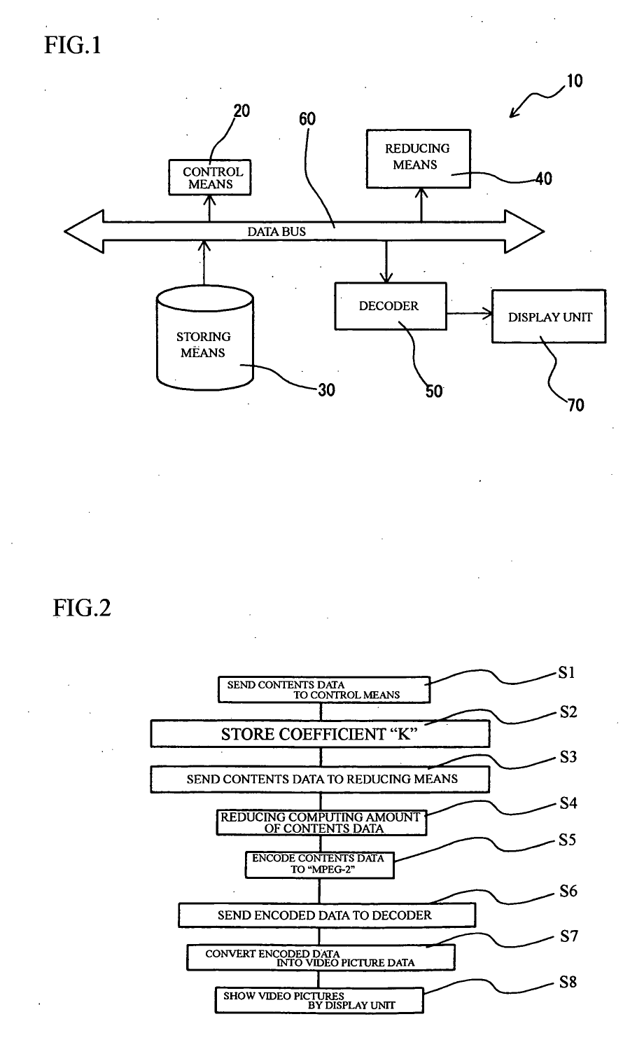

FIG. 1 is a block diagram showing a brief structure of the apparatus 10 for reproducing contents data.

The apparatus 10 of the present embodiment comprises: control means 20 including a CPU, etc.; means 30 for storing contents data, whose compression format is, for example, MPEG (Moving Picture Experts Group)-2, the storing means 30 including a hard disk, e.g., DVD disk; means 40 for reducing a computing amount of the contents data stored in the storing means 30, the reducing means 40 including a translator, a transcoder, etc. constituted by LSI chips, etc.; a decoder 50 converting the contents data, whose computing amount of data has been reduced by the reducing means 40, into video data; a data bus 60 for interchanging data; and a display unit 70 for displaying video pictures processed by the decoder 50. A personal computer may act as the apparatus 10. Note that, the display unit 70 may be separated from the apparatus 10.

Next, the compression format MPEG-2 will be explained.

The MPEG-2 compressed data are constituted by an SH (Sequence Header) section and a GOP (group of pictures) section. The SH section includes data of horizontal and vertical size of video pictures, aspect ratio of pixels, picture rate, bit rate, buffer size of video buffer verifier (VBV), constraint parameter flags, etc.

The GOP section includes I-pictures, P-pictures and B-pictures. The I-pictures are pictures in frames or main data of the GOP section called key frames. The P-pictures are pictures between frames and constituted by only varying parts of the key frames. The B-pictures are the I-pictures of the past and the future, and they are used as data for estimating the P-pictures. By the I-pictures, the P-pictures and the B-pictures of the GOP section, a plurality of frames can be reproduced in order so that video pictures can be displayed.

Next, the method of reproducing contents data with the apparatus 10 will be explained. Note that, in the present embodiment, the contents data is compressed as a MPEG-2 file, but the data formatted in other file formats may be used.

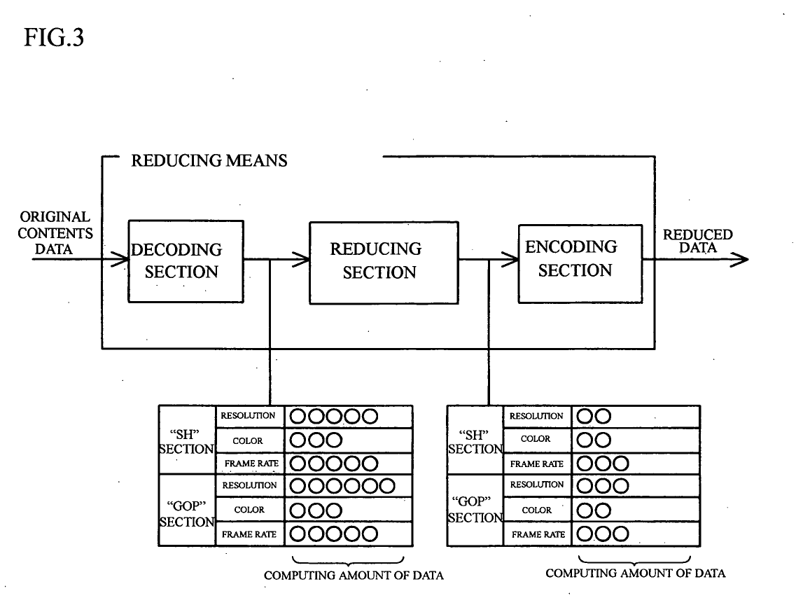

FIG. 2 is a flowchart explaining the steps of processing the contents data for a special reproduction. FIG. 3 is a schematic view showing a process of reducing a computing amount of the contents data performed by the reducing means 40. Note that, in the reproducing apparatus 10, commands for reproducing video pictures at predetermined speeds, as special reproduction, have been previously set in the reproducing apparatus 10.

When a user selects contents data stored in the storing means 30 and inputs a command of the special reproduction, the selected contents data are sent to the control means 20 via the data bus 60 (Step S1). The control means 20 stores the ratio of a maximum computing amount B of the decoder 50 to a computing amount A of the received contents data, which will be processed by the decoder 50 for special reproduction, in the storing means 30, as a reduction coefficient K=B/A (Step S2). Then, the contents data are sent to the reducing means 40 via the data bus 60 (Step S3). The reducing means 40 reduces the computing amount of the contents data by multiplying the amount of the contents data by the reduction coefficient K.

Concretely, the reducing means 40 once processes the SH section and the GOP section, which includes the I-pictures, the P-pictures and the B-pictures, so as to reduce or translate specific data of the SH section and the GOP section, which depend on resolution, frame rate and number of colors, so that the computing amount of the data can be reduced (Step S4).

Next, the reducing means 40 encodes the reduced data, whose SH section and GOP section have been reduced, as the MPEG-2 file (Step S5), then the MPEG-2 file data are sent to the decoder 50 via the data bus 60 (Step S6).

In the present embodiment, the control means 20 computes influences of resolution, frame rate and number of colors to the computing amount of the contents data on the basis of a prescribed formula. Note that, the reducing means 40 sends the received contents data to the decoder 50 via the data bus 60, without performing any treatment to the received contents data, when no command for the special reproduction is inputted.

The reduced contents data, whose computing amount of data to be decoded by the decoder 50 has been reduced by multiplying the coefficient K by the reducing means 40, are converted into video data by the decoder 50 (Step S7), and the decoded video data are shown by the display unit 70 (Step S8).

As described above, since the reducing means 40 reduces the computing amount of the contents data to be sent to the decoder 50 by multiplying the amount of the contents data by the coefficient K, the actual computing amount of the contents data can be smaller than the limit computing amount of the decoder 50 even in case of the special reproductions. Therefore, the data, which are essential for displaying video pictures, can be securely decoded, so that the video pictures of the special reproduction can be smoothly shown by the display unit 70.

### EXAMPLE

An example of the special reproduction of contents data will be explained.

In the present example, the reproducing apparatus 10 reproduced the contents data at double speed (2× speed) of a standard reproduction speed (1× speed).

The user selected object contents data from the storing means 30. The selected contents data were sent to the control means 20. Since the user-selected reproduction speed was double speed, the control means 20 temporally stored the reproduction coefficient K=½ or 0.5 and the computing amount of the received contents data, which were decoded by the decoder 50, in the storing means 30. When the user inputted the command for reproducing data at double speed, the control means 20 read the coefficient K and made the reducing means 40 perform the translation treatment. Namely, the reducing means 40 reduced the resolution, the frame rate and the number of colors of the original contents data so as to reduce the computing amount of the original contents data to half.

The reduced contents data, whose computing amount had been reduced to half by the reducing means 40, were encoded to the MPEG-2 file by the reducing means 40 and sent to the decoder 50. The decoder 50 reproduced the original contents data at the standard speed only, but the computing amount of the contents data sent from the reducing means 40 was a half of the amount of the original contents data. Therefore, the decoder 50 could substantially decode the half of the data at double speed, so that smooth video pictures could be shown, without dropping frames, by the display unit 70.

As described above, in the above described embodiment, the data of the SH section and the GOP section, which constitute the MPEG-2 file, are reduced. Namely, the resolution, the frame rate and the number of colors are reduced, so that the computing amount of the contents data can be reduced. The reduction of the computing amount of the contents data is not limited to the embodiment.

The GOP section is constituted by the I-pictures, the P-pictures and the B-pictures, and the B-pictures are supplemental intermediate data existed between the I-pictures and the P-pictures. Even if a part of the B-pictures are deleted, no visual problems occur during the special reproduction. Therefore, the computing amount of the contents data may be reduced by deleting a part of the B-pictures of the GOP section.

In the above described embodiment, the reducing means 40 performs the translation treatment, in which the original contents data are once processed then the resolution, the frame rate and the number of colors are reduced, but the reducing means 40 may reduce the computing amount of the contents data without picture processing.

Reference data of influencing the computing amount of the contents data by the reduction of the resolution, the frame rate and the number of colors, may be previously stored in the storing means 30. In this case, the control means 20 reads the reference data from the storing means 30 and makes the reducing means 40 perform the translation treatment on the basis of the reference data.

In the above described embodiment, the reducing means 40 performs the so-called translation treatment. In another case, the reducing means 40 may reduce the computing amount of the contents data by performing a transcoding treatment, in which the MPEG-2 data are converted into MPEG-1 data.

By performing the transcoding treatment, the special reproductions, e.g., reproduction with fast-forwarding, reproduction with fast rewinding, slow reproduction, slow reproduction with rewinding, of the contents data can be executed.

Further, a plurality of reproducing speed may be set so as to optionally select the reproducing speed.

Note that, if the computing amount of the original contents data cannot be reduced to a multiple of the coefficient K, the contents data, which has been maximally reduced, are reproduce.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of reproducing contents data stored in storing means at a speed other than normal speed,
comprising the steps of:
determining a reduction coefficient for reducing a computing amount of the contents data to be actually decoded by a decoder, which processes video data of the contents data, on the basis of an amount of the data to be computed by the decoder while reproducing the contents data and a computable data amount of the decoder;
reducing the computing amount of the contents data to be actually decoded by the decoder to a multiple of the reduction coefficient;
processing video data of the contents data, whose computing amount has been reduced by the decoder; and
displaying the processed video data of the contents data by display means.

2. The method according to claim 1,
wherein the computing amount of the contents data to be actually decoded by the decoder is reduced by translating the contents data.

3. The method according to claim 1,
wherein the computing amount of the contents data to be actually decoded by the decoder is reduced by transcoding the contents data.

4. An apparatus for reproducing contents data,
comprising:
means for storing the contents data;
means for reducing a computing amount of the contents data;
a decoder for processing video data of the contents data, whose computing amount has been reduced by said reducing means;
display means; and
control means,
wherein said control means determines a reduction coefficient for reducing a computing amount of the contents data to be actually decoded by a decoder, which processes video data of the contents data, on the basis of an amount of the data to be computed by the decoder while reproducing the contents data and a computable data amount of the decoder,
reduces the computing amount of the contents data to be actually decoded by the decoder to a multiple of the reduction coefficient,
processes video data of the contents data, whose computing amount has been reduced by the decoder, and
displays the processed video data of the contents data by said display means.

5. The apparatus according to claim 4,
wherein said reducing means is a translator.

6. The apparatus according to claim 4,
wherein said reducing means is a transcoder.
